(19) United States
(12) Patent Application Publication
(10) Pub. No.: US 2025/0096233 A1
(43) Pub. Date: Mar. 20, 2025

(54) MANUFACTURING METHOD OF LITHIUM BATTERY NEGATIVE ELECTRODE

(71) Applicant: NAN YA PLASTICS CORPORATION, Taipei City (TW)

(72) Inventors: Te-Chao Liao, Taipei City (TW); Chun-Che Tsao, Taipei City (TW); Li-Ting Wang, Taipei City (TW)

(73) Assignee: NAN YA PLASTICS CORPORATION, Taipei City (TW)

(21) Appl. No.: 18/493,718

(22) Filed: Oct. 24, 2023

(30) Foreign Application Priority Data
Sep. 18, 2023 (TW) 112135560

(51) Int. Cl. H01M 4/139; H01M 4/02

(52) U.S. Cl. CPC H01M 4/139; H01M 2004/027

(57) ABSTRACT

A manufacturing method of a lithium battery negative electrode includes the following. A copper foil is providing. An electroplating process is performed to form a lithium deposition layer on the copper foil. An electrolyte solution used in the electroplating process includes an organic solvent and fluorine-containing lithium salt. The organic solvent includes ester solvents, ether solvents, alcohol solvents, or combinations thereof, and the fluorine-containing lithium salt includes LiPF₆, LiFSI, LiTF, LiDFOB, LiTFSI, or combinations thereof.

### CROSS-REFERENCE TO RELATED APPLICATION

This application claims the priority benefit of Taiwan application serial no. 112135560, filed on Sep. 18, 2023. The entirety of the above-mentioned patent application is hereby incorporated by reference herein and made a part of this specification.

### BACKGROUND

### Technical Field

The disclosure relates to a manufacturing method of a lithium battery negative electrode.

### Description of Related Art

Lithium metal is used for a lithium battery as a negative electrode, and the lithium battery has high theoretical capacity (such as 2047 mAh/cm³ to 3860 mAh/cm³, etc.) and low reduction potential (such as 3.04V). Advantages thereof over a standard hydrogen electrode (SHE) are characteristics such as light weight and a small ionic radius, and it is considered to be suitable for the development of high energy density batteries. However, there are still issues that are required to be overcome.

For example, when pure lithium metal is used as the negative electrode, lithium dendrites are prone to occur during charging and discharging. As the battery operation time becomes longer, an isolation film may be punctured and come into contact with a positive electrode, causing problems such as short circuit and thermal runaway, thereby reducing stability and cycle life of the lithium battery.

### SUMMARY

The disclosure provides a manufacturing method of a lithium battery negative electrode, in which the manufactured lithium battery negative electrode may effectively improve stability and cycle life of an assembled lithium battery.

A manufacturing method of a lithium battery negative electrode in the disclosure includes the following. A copper foil is provided. An electroplating process is performed to form a lithium deposition layer on the copper foil. An electrolyte solution used in the electroplating process includes an organic solvent and fluorine-containing lithium salt. The organic solvent includes an ester solvent, an ether solvent, an alcohol solvent, or a combination thereof, and the fluorine-containing lithium salt includes lithium hexafluorophosphate (LiPF₆), lithium bis(fluorosulfonyl)imide (LiFSI), lithium trifluoromethanesulfonate (LiTF), lithium difluoro(oxalato)borate (LiDFOB), lithium bis(trifluoromethanesulfonyl)imide (LiTFSI), or a combination thereof.

In an embodiment of the disclosure, the electrolyte solution is formed by a mixture of lithium salt and the ester solvent or the ether solvent or the ester solvent and the ether solvent. The electrolyte solution at least includes the ester solvent preferably, and a volume ratio thereof accounts for more than 50%.

In an embodiment of the disclosure, a usage ratio of the fluorine-containing lithium salt in the electrolyte solution is between 0.1 mol/L and 5 mol/L.

In an embodiment of the disclosure, a current density in the electroplating process is between 1 mA/cm² and 5 mA/cm².

In an embodiment of the disclosure, a thickness of the lithium deposition layer is between 1 micron and 20 microns.

In an embodiment of the disclosure, the electrolyte solution further includes an additive, and the additive includes lithium nitrate (LiNO₃).

In an embodiment of the disclosure, a usage ratio of the additive in the electrolyte solution is between 1 wt % and 10 wt %.

In an embodiment of the disclosure, the organic solvent is selected from a combination of the ester solvent and the ether solvent.

In an embodiment of the disclosure, a volume ratio of the ester solvent and the ether solvent is between 3:1 and 1:1.

In an embodiment of the disclosure, a surface of the lithium deposition layer includes a fluorine-containing compound.

Based on the above, the manufacturing method for the lithium battery negative electrode in the disclosure is to form the copper-lithium composite structure through the electroplating process, and through the design of the electrolyte solution of the electroplating process, the fluorine-containing protective film may be formed on the surface thereof. In this way, the generation of the lithium dendrites may be effectively reduced when the lithium battery is charged and discharged, and the probability of the problems such as short circuit and thermal runaway is reduced. That is to say, the lithium battery negative electrode manufactured through the manufacturing method in the disclosure may effectively improve the stability and cycle life of the assembled lithium battery.

In order for the aforementioned features and advantages of the disclosure to be more comprehensible, embodiments accompanied with drawings are described in detail below.

### BRIEF DESCRIPTION OF THE DRAWINGS

FIG. 1 is a flow chart of a manufacturing method of a lithium battery negative electrode according to an embodiment of the disclosure.

FIG. 2 is a schematic structural view of a lithium battery negative electrode according to an embodiment of the disclosure.

FIGS. 3, 4, 5, 6, 7, 8, 9, and 10 are schematic views of SEM according to Embodiment 1, Embodiment 2, Embodiment 3, Embodiment 4, Embodiment 5, Embodiment 6, Comparative Example 1, and Comparative Example 2 of the disclosure.

FIGS. 11, 12, 13, 14, 15, 16, 17, and 18 are schematic views of changes in area capacity under different current densities according to Embodiment 1, Embodiment 2, Embodiment 3, Embodiment 4, Embodiment 5, Embodiment 6, Comparative Example 1, and Comparative Example 2 of the disclosure.

### DETAILED DESCRIPTION OF DISCLOSED EMBODIMENTS

In the following detailed description, for purposes of explanation and not limitation, exemplary embodiments disclosing specific details are set forth in order to provide a thorough understanding of the various principles of the disclosure. It will be apparent, however, to one of ordinary skill in the art, having been benefited from this disclosure, that the present disclosure may be practiced in other embodiments that depart from the specific details disclosed herein. Furthermore, descriptions of commonly-known devices, methods, and materials may be omitted so as not to shift the focus from the description of the various principles of the present disclosure.

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

Unless otherwise stated, the term “between” used in this specification to define numerical ranges is intended to cover ranges equal to and between the stated endpoints. For instance, if a size range is between a first value and a second value, the size range may cover the first value, the second value, and any value between the first value and the second value.

In this document, non-limiting terms (such as: may, can, for example, or other similar terms) are non-essential or optional implementation, inclusion, addition or presence.

Unless otherwise defined, all terms (including technical and scientific terms) used herein have the same meaning as commonly understood by one of ordinary skill in the art to which this disclosure belongs. It will also be understood that terms (such as those defined in commonly used dictionaries) should be interpreted to have meanings consistent with those in the relevant technical context and should not be interpreted in an idealized or overly formal sense, unless explicitly defined as such.

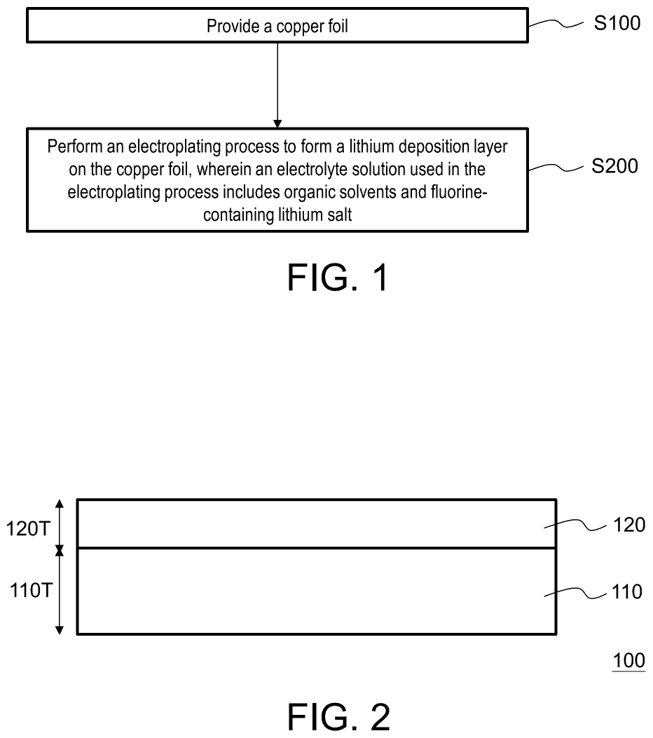

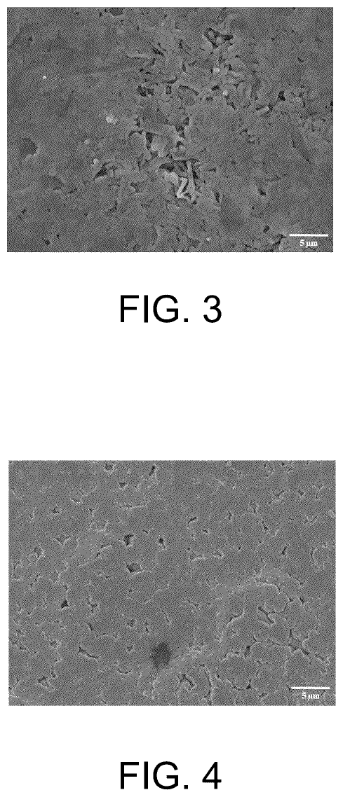

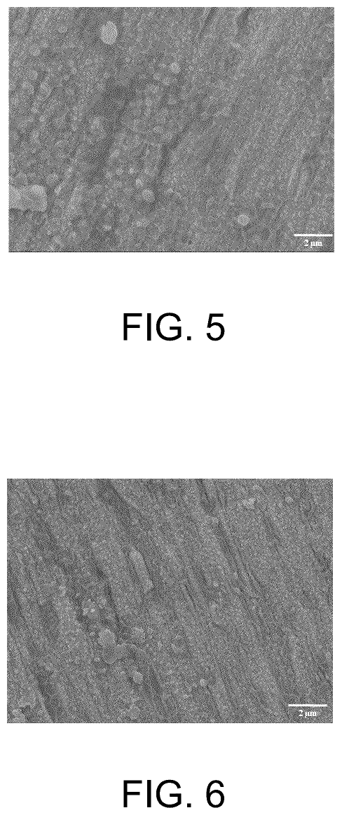

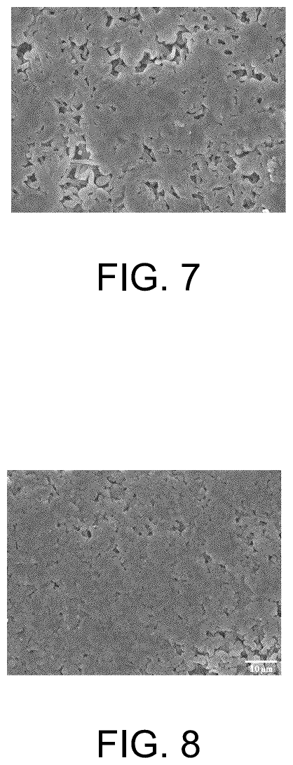

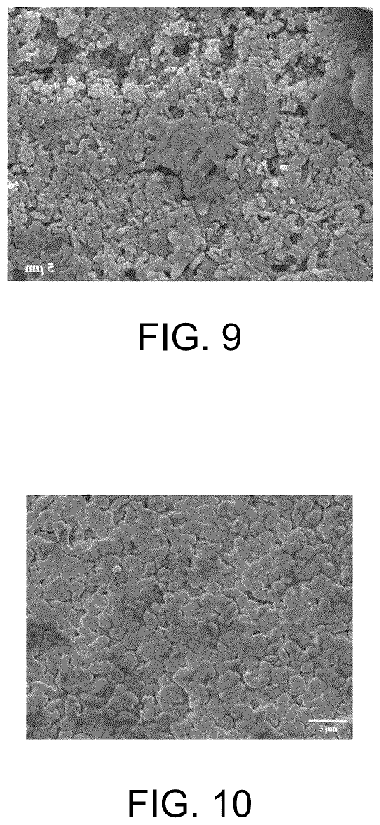

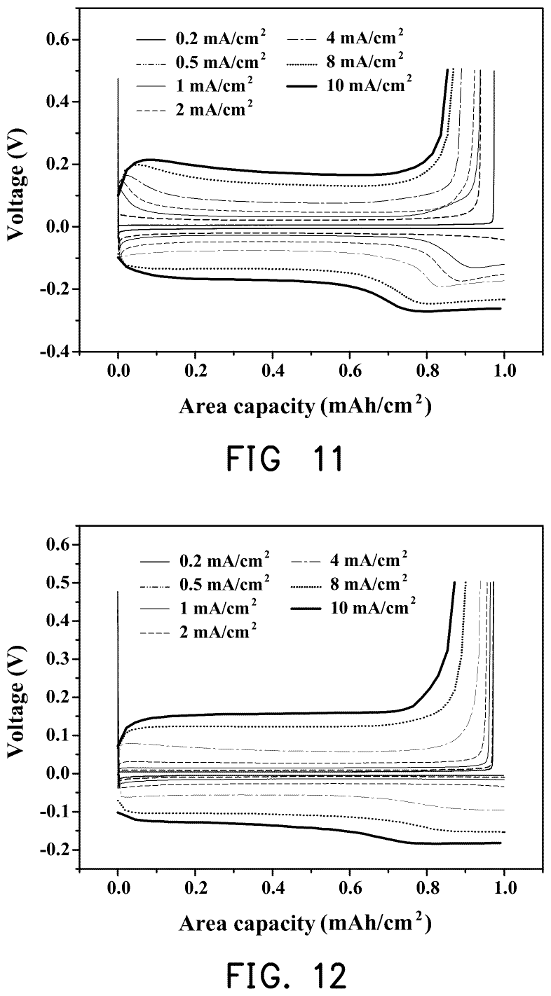

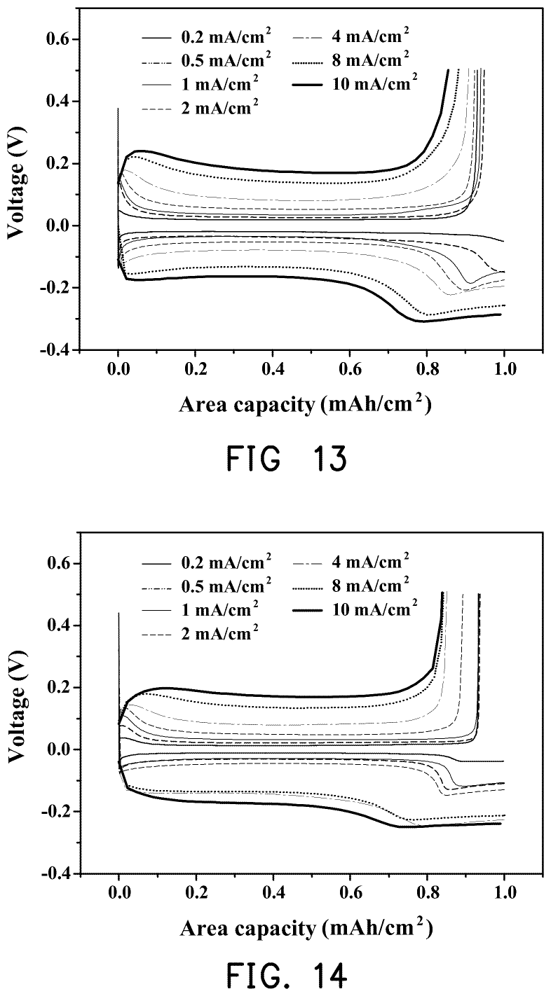

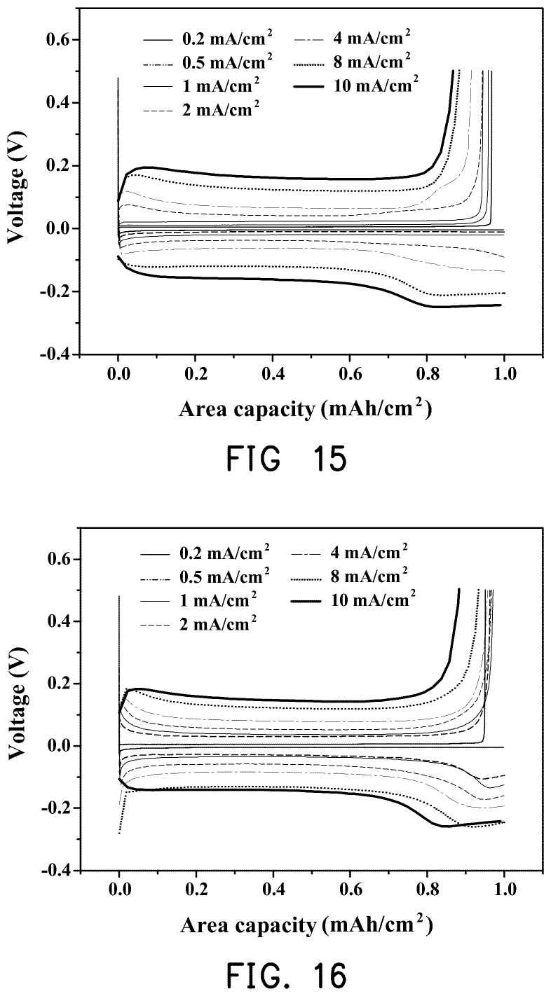

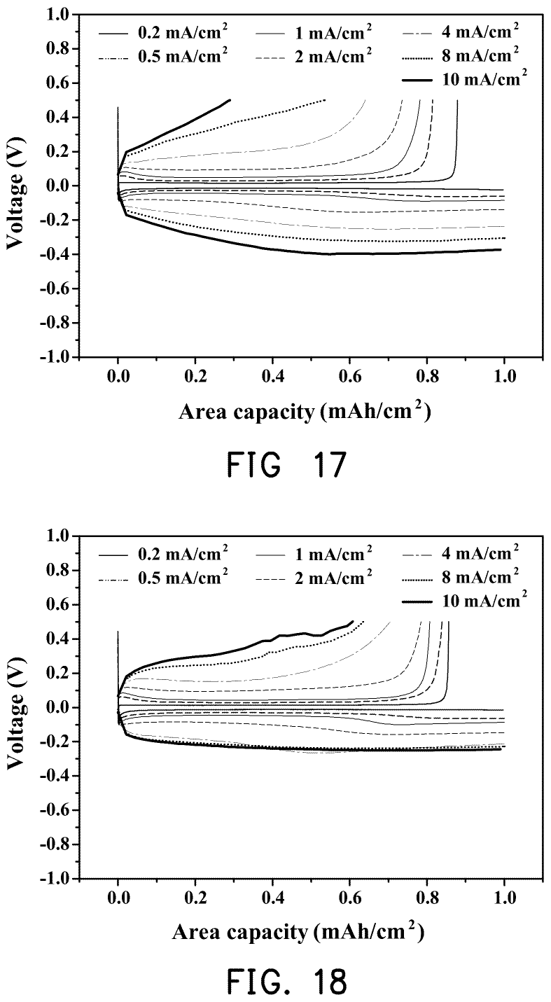

FIG. 1 is a flow chart of a manufacturing method of a lithium battery negative electrode according to an embodiment of the disclosure. FIG. 2 is a schematic structural view of a lithium battery negative electrode according to an embodiment of the disclosure. Referring to FIGS. 1 and 2, a manufacturing method of a lithium battery negative electrode 100 in this embodiment may include at least the following steps. FIGS. 3, 4, 5, 6, 7, 8, 9, and 10 are schematic views of SEM according to Embodiment 1, Embodiment 2, Embodiment 3, Embodiment 4, Embodiment 5, Embodiment 6, Comparative Example 1, and Comparative Example 2 of the disclosure. FIGS. 11, 12, 13, 14, 15, 16, 17, and 18 are schematic views of changes in area capacity under different current densities according to Embodiment 1, Embodiment 2, Embodiment 3, Embodiment 4, Embodiment 5, Embodiment 6, Comparative Example 1, and Comparative Example 2 of the disclosure.

First, a copper foil 110 is provided (step S100). A thickness 110T of the copper foil 110 is, for example, between 5 micrometers (um) and 10 micrometers, but the disclosure is not limited thereto. Next, an electroplating process is performed to form a lithium deposition layer 120 on the copper foil 110, and an electrolyte solution used in the electroplating process includes organic solvents and fluorine-containing lithium salt (step S200).

Furthermore, the organic solvents include ester solvents, ether solvents, alcohol solvents or combinations thereof (in some embodiments, the electrolyte solution may include at least one or more organic solvents, such as ester or ether solvents, or a mixture of esters and ethers, and the electrolyte solution may preferably include at least the ester solvents), and the fluorine-containing lithium salt includes lithium hexafluorophosphate, lithium bis(fluorosulfonyl)imide, lithium trifluoromethanesulfonate, lithium difluoro(oxalato)borate, lithium bis(trifluoromethanesulfonyl)imide, or combinations thereof. The fluorine-containing lithium salt may be used as an electrolytic solute to stabilize the lithium battery negative electrode 100.

Accordingly, the manufacturing method of the lithium battery negative electrode in this embodiment is to form a copper-lithium composite structure through the electroplating process (as shown in the stacked copper foil 110 and lithium deposition layer 120 in FIG. 2), and through a design of the electrolyte solution of the electroplating process, a fluorine-containing protective film may be formed on a surface thereof. In this way, generation of lithium dendrites may be effectively reduced when the lithium battery is charged and discharged, and probability of problems such as short circuit and thermal runaway is reduced. That is to say, the lithium battery negative electrode 100 manufactured through the manufacturing method in this embodiment may effectively improve stability and cycle life of the assembled lithium battery. Here, the lithium battery may be a lithium secondary battery, a lithium metal solid state battery, or the like.

In some embodiments, the fluorine-containing protective film refers to a surface (a top surface in FIG. 2) of the lithium deposition layer 120 including fluorine-containing compounds (generated along with the electroplating process). Therefore, the lithium deposition layer 120 is not a pure lithium metal layer. A type of the fluorine-containing compound may depend on a type of the fluorine-containing lithium salt actually used in the electrolyte solution.

In some embodiments, the fluorine-containing protective film may be regarded as a solid electrolyte interface (SEI) with a higher lithium content, and the solid electrolyte interface designed and formed during a lithium electrodeposition process on the copper foil through the electrolyte solution in this embodiment has characteristics such as uniformity and stability. Therefore, it may suppress formation of the lithium dendrites when assembled into the lithium battery, and has high coulombic efficiency (CE). For example, the coulombic efficiency is greater than 90%. However, the disclosure is not limited thereto.

In some embodiments, a thickness 120T of the lithium deposition layer 120 formed through the manufacturing method of the lithium battery negative electrode in this embodiment is at least less than 30 microns, which may be, for example, between 1 micron and 20 microns (for example, 1 micron, 3 microns, 5 microns, 8 microns, 12 microns, 15 microns, 20 microns, or any value between 1 micron and 20 microns). That is, it may operate well during a charge and discharge cycle. Therefore, compared to the thickness of the lithium metal layer (which may even reach 300 microns) formed by current technology (such as a cold rolling process), the thickness 120T of the lithium deposition layer 120 may be significantly reduced, so that the lithium battery has more advantages in cost and energy density. However, the disclosure is not limited thereto.

In some embodiments, the thickness 110T of the copper foil 110 is 6 microns, and the thickness 120T of the lithium deposition layer 120 is 5 microns to achieve better effects. However, the disclosure is not limited thereto.

In some embodiments, a usage ratio of the fluorine-containing lithium salt in the electrolyte solution is between 0.1 mol/L (M) and 5 mol/L (M). In this way, under the above ratio of the electrolyte solution, a current density in the electroplating process may be at least greater than 1 mA/cm², for example, between 1 mA/cm² and 5 mA/cm². Compared to the small current density commonly used in the current technology (such as 0.1 mA/cm² to 0.5 mA/cm²), in the disclosure, the electroplating time may be reduced to increase the yield, while reducing the generation of the lithium dendrites and achieve higher coulombic efficiency, which is beneficial to commercial mass production. However, the disclosure is not limited thereto.

In some embodiments, the organic solvents include ethylene carbonate (EC), diethyl carbonate (DEC), fluoroethylene carbonate (FEC), dimethyl carbonate (DMC), propylene carbonate (PC), 1, 2-dimethoxyethane (DME), 1, 1-diethoxyethane (DEE), 1, 3-dioxolane (DOL), or combinations thereof. However, the disclosure is not limited thereto. The organic solvents may also be any other suitable ester solvent, ether solvent, or alcohol solvent.

In some embodiments, the electrolyte solution further includes an additive, and the additive includes lithium nitrate (LiNO₃), so that a surface morphology thereof has a better state, which may, for example, improve surface flatness in an electroplating system of a nucleation reaction. Therefore, probability of uneven nucleation and surface unevenness may be reduced, thereby further reducing probability of forming the lithium dendrites. However, the disclosure is not limited thereto. The additive may be optionally configured. That is, the use of the additive may also be omitted in the electrolyte solution. Here, a usage ratio of the additive in the electrolyte solution is, for example, between 1 wt % and 10 wt %.

In some embodiments, the electrolyte solution is formed by the organic solvent, the fluorine-containing lithium salt, and the additive, but the disclosure is not limited thereto. According to actual design requirements, in other embodiments, the electrolyte solution may optionally include other ingredients.

In some embodiments, the organic solvent is selected from a combination of the ester solvents and the ether solvents, and a volume ratio of the aforementioned ester solvents and ether solvents is between 3:1 and 1:1 to further improve electroplating quality. However, the disclosure is not limited thereto.

In some embodiments, the organic solvent may be formed by ethylene carbonate (EC), diethyl carbonate (DEC), 1, 3-Dioxolane (DOL) mixed with 1, 2-Dimethoxyethane (DME), and 1, 1-Diethoxyethane (DEE). However, the disclosure is not limited thereto.

In addition, due to a continuous and irreversible reaction between excess highly active lithium metal and the electrolyte solution in the lithium battery, an excess SEI layer is formed at an interface between the electrolyte solution and a lithium metal electrode, causing effective active lithium to continue to be consumed, resulting in low coulombic efficiency. In addition, during long-term operation of the lithium battery, such as plating/stripping, the effective active lithium is stripped from a collector plate and covered by the SEI layer, which easily causes a failure of the active lithium, which is called a phenomenon of dead lithium. After the aforementioned design of the electrolyte solution in the disclosure, the occurrence of the phenomenon of dead lithium may be reduced. For example, a content of dead lithium is less than 25%. However, the disclosure is not limited thereto.

It should be noted that the electrolyte solution in the subsequently assembled lithium battery may also be designed similarly to the electrolyte solution in the disclosure to have characteristics such as a wide potential window, good lithium ion conductivity (such as greater than 10⁻⁴ S/cm), a high lithium ion conductivity coefficient, and non-conductive electrons (less than 10⁻¹⁰ S/cm), and have both chemical stability and battery compatibility. However, the disclosure is not limited thereto.

In addition, through the aforementioned design of the electrolyte solution, the lithium battery negative electrode in the disclosure may effectively retain the high energy density of lithium metal and improve problems of excess lithium and poor lithium plating/stripping efficiency of a negative electrode copper collector plate in an anodeless battery. However, the disclosure is not limited thereto.

The following experimental data are listed here to illustrate effects of the disclosure. However, the scope of claims in the disclosure is not limited to the scope of the embodiments.

Embodiment 1: It is formed by LiTFSI of 1M (EC:DEE=1:1), LiNO₃ of 1 wt %, and FEC of 0.5 wt %. LiTFSI of 1M (EC:DEE=1:1) indicates that there is 1 mole of LiTFSI in 1 liter of electrolyte solution. 1 liter of electrolyte solution is formed by EC and DEE in a ratio of 1:1, and wt % is compared to the overall weight of the electrolyte solution. Similar expressions below have similar definitions. Therefore, the same details will not be repeated in the following.

Embodiment 2: It is formed by LiTFSI of 1M (EC:DEE=1:1), LiNO₃ of 2 wt %, and FEC of 0.5 wt %.

Embodiment 3: It is formed by LiTFSI of 1M (EC:DEE=1:1), dimethyl sulfoxide (DMSO) of 1 wt %, LiNO₃ of 3 wt %, and FEC of 0.5 wt %.

Embodiment 4: It is formed by LiTFSI of 1M (EC:DEE=1:1), LiNO₃ of 1 wt %, and FEC of 0.5 wt %.

Embodiment 5: It is formed by LiTFSI of 1M (EC:DEE=1:1), LiNO₃ of 2 wt %, and FEC of 0.5 wt %.

Embodiment 6: It is formed by LiTFSI of 1M (EC:DEE=1:1), LiNO₃ of 3 wt %, and FEC of 0.5 wt %.

Comparative Example 1: It is formed by LiPF₆ of 1M (EC:DEC=1:1).

Comparative Example 2: It is formed by LiTFSI of 1M (DOL:DME=1:1) and LiNO₃ of 1 wt %.

The formulas shown in Embodiments 1 to 6 and Comparative Examples 1 and 2 are used as the electrolyte solution, and components of a CR2032 button battery are used to assemble a lithium copper half-cell, using lithium as a lithium source for electroplating. At 1 mA/cm², electroplating is performed for 1 hour (1 mAh/cm²), the thickness of the lithium deposition layer is about 5 microns (um), and a plated lithium-copper composite foil (the lithium battery negative electrode) is taken out.

The data in Table 1 is a test for assembling the above lithium-copper composite foil into the lithium copper half-cell, using a three-layer isolation film of PP/PE/PP and using the battery electrolyte solution formed by LiTFSI of 1M (EC:DME=1:1), LiNO₃ of 5 wt %, and FEC of 0.5 wt %, and the coulombic efficiency at different current densities is tested.

After comparing results of Embodiments and Comparative Examples in Table 1, the following conclusion may be drawn. Compared with the electrolyte solution in Comparative Examples, the lithium-copper composite foil plated with the electrolyte solution Embodiments has advantages in the coulombic efficiency under different current densities, which may be confirmed that the quality of the lithium layer plated by the optimized formula of the electrolyte solution in the disclosure (such as Example 1 and Comparative Example 2, which at least includes ether additives (FEC)) is better than the formula of the electrolyte solution in Comparative Examples, and may have significant excellent performance when the current density is greater than or equal to 2 mA/cm².

TABLE 1

| | | | | | | | Comparative | Comparative |
|---|---|---|---|---|---|---|---|---|
| | Embodiment | Embodiment | Embodiment | Embodiment | Embodiment | Embodiment | Example | Example |
| | 1 | 2 | 3 | 4 | 5 | 6 | 1 | 2 |
| | Coulombic Efficiency | | | | | | | |
| Current density (0.2 mA/cm²) | 97.6% | 97.6% | 93.2% | 93.5% | 96.9% | 95.2% | 95.7% | 85.6% |
| Current density (0.5 mA/cm²) | 93.8% | 97.4% | 94.7% | 94.4% | 96.8% | 96.3% | 95.2% | 83.9% |
| Current density (1 mA/cm²) | 93.9% | 97.2% | 93.9% | 93.4% | 95.5% | 97.1% | 98.0% | 80.7% |
| Current density (2 mA/cm²) | 92.3% | 96.4% | 92.3% | 89.2% | 94.6% | 96.7% | 73.7% | 78.5% |
| Current density (4 mA/cm²) | 88.9% | 93.4% | 90.8% | 85.0% | 93.1% | 95.7% | 64.1% | 70.5% |
| Current density (8 mA/cm²) | 86.8% | 89.9% | 88.2% | 84.1% | 89.4% | 93.3% | 53.4% | 63.5% |
| Current density (10 mA/cm²) | 86.2% | 88.1% | 86.3% | 84.8% | 87.6% | 88.2% | 29.0% | 60.7% |

Comparing to electrical results from FIGS. 3 to 18, the smoother the surface of the plated lithium layer, the better the coulombic efficiency under high current density. A SEM image in Comparative Example 1 shows that obvious granular and strip-like lithium dendrites appear on the surface, and also begins to have granular uneven surfaces in Comparative Example 2. Therefore, the electrical results are also poor.

In addition, weight loss of the lithium layer is measured before and after electrical properties of the lithium copper half-cell are tested to determine the quality of the lithium layer. The better the quality of the lithium layer, the less lithium is lost. The lithium lost is called dead lithium here. The weight of lithium before electroplating is called the weight of electroplated lithium. The higher the percentage of dead lithium, the more positive correlation there is with the electrical performance results. Such method may be used to judge the quality of the plated lithium layer. According to the results in Table 2 below, compared to Comparative Examples 1 and 2, there is a significant improvement in the percentage of dead lithium in Embodiments 1 to 6.

TABLE 2

| | | | | | | | Comparative | Comparative |
|---|---|---|---|---|---|---|---|---|
| | Embodiment | Embodiment | Embodiment | Embodiment | Embodiment | Embodiment | Example | Example |
| | 1 | 2 | 3 | 4 | 5 | 6 | 1 | 2 |
| Weight of electroplated | 0.203 | 0.224 | 0.217 | 0.211 | 0.22 | 0.21 | 0.199 | 0.204 |
| lithium (mg/cm²) | | | | | | | | |
| Weight of dead lithium | 0.032 | 0.026 | 0.032 | 0.042 | 0.031 | 0.027 | 0.069 | 0.058 |
| (mg/cm²) | | | | | | | | |
| Percentage of dead | 15.8 | 11.6 | 14.7 | 19.9 | 14.1 | 12.9 | 34.7 | 28.4 |
| lithium (%) | | | | | | | | |

Based on the above, the manufacturing method for the lithium battery negative electrode in the disclosure is to form the copper-lithium composite structure through the electroplating process, and through the design of the electrolyte solution of the electroplating process, the fluorine-containing protective film may be formed on the surface thereof. In this way, the generation of the lithium dendrites may be effectively reduced when the lithium battery is charged and discharged, and the probability of the problems such as short circuit and thermal runaway is reduced. That is to say, the lithium battery negative electrode manufactured through the manufacturing method in the disclosure may effectively improve the stability and cycle life of the assembled lithium battery.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A manufacturing method of a lithium battery negative electrode, comprising:
providing a copper foil; and
performing an electroplating process to form a lithium deposition layer on the copper foil, wherein an electrolyte solution used in the electroplating process comprises an organic solvent and fluorine-containing lithium salt, wherein the organic solvent comprises an ester solvent, an ether solvent, an alcohol solvent, or a combination thereof, and the fluorine-containing lithium salt comprises lithium hexafluorophosphate, lithium bis(fluorosulfonyl)imide, lithium trifluoromethanesulfonate, lithium difluoro(oxalato)borate, lithium bis(trifluoromethanesulfonyl)imide, or a combination thereof.

2. The manufacturing method of the lithium battery negative electrode according to claim 1, wherein the electrolyte solution at least comprises the ester solvent, and a volume ratio thereof accounts for more than 50%.

3. The manufacturing method of the lithium battery negative electrode according to claim 1, wherein a usage ratio of the fluorine-containing lithium salt in the electrolyte solution is between 0.1 mol/L and 5 mol/L.

4. The manufacturing method of the lithium battery negative electrode according to claim 1, wherein a current density in the electroplating process is between 1 mA/cm² and 5 mA/cm².

5. The manufacturing method of the lithium battery negative electrode according to claim 1, wherein a thickness of the lithium deposition layer is between 1 micron and 20 microns.

6. The manufacturing method of the lithium battery negative electrode according to claim 1, wherein the electrolyte solution further comprises an additive, and the additive comprises lithium nitrate.

7. The manufacturing method of the lithium battery negative electrode according to claim 6, wherein a usage ratio of the additive in the electrolyte solution is between 1 wt % and 10 wt %.

8. The manufacturing method of the lithium battery negative electrode according to claim 1, wherein the organic solvent is selected from a combination of the ester solvent and the ether solvent.

9. The manufacturing method of the lithium battery negative electrode according to claim 8, wherein a volume ratio of the ester solvent and the ether solvent is between 3:1 and 1:1.

10. The manufacturing method of the lithium battery negative electrode according to claim 1, wherein a surface of the lithium deposition layer comprises a fluorine-containing compound.
